(19) United States
(12) Patent Application Publication
(10) Pub. No.: US 2009/0327864 A1
(43) Pub. Date: Dec. 31, 2009

(54) Method of Transmitting a Multimedia Message Over a Network

(76) Inventors: Kent Bogestam, Hagersten (SE); Ignacio Más Ivars, Sollentuna (SE)

Correspondence Address: ERICSSON INC., 6300 LEGACY DRIVE, M/S EVR 1-C-11, PLANO, TX, 75024, US

(21) Appl. No.: 12/307,401

(22) PCT Filed: Jul. 6, 2006
(86) PCT No.: PCT/EP06/63996

§ 371 Date: Jul. 24, 2009

(51) Int. Cl. G06F 15/16; G06F 17/00

(52) U.S. Cl. 715/234; 709/206

(57) ABSTRACT

A method of transmitting a multimedia message over a network. A Message Session Relay Protocol message is generated at a first terminal. The message comprises a plurality of data portions and a description portion, and the description portion comprises instructions for individually handling each data portion. The message is sent from the first terminal such that the description portion is sent ahead of the data portions. When the description portion and data portions are received at a second terminal, each data portions is handled at the second terminal in accordance with the instructions for handling the data portion.

### FIELD OF THE INVENTION

The invention relates to the field of transmitting a multimedia message over a network, and in particular to transmitting a Message Session Relay Protocol (MSRP) message.

### BACKGROUND TO THE INVENTION

IP Multimedia (IPMM) is an example of a service that provides a dynamic combination of voice, video, messaging, data, etc, within the same session. By growing the numbers of basic applications and the media which it is possible to combine, the number of services offered to the end users will grow, and the inter-personal communication experience will be enriched. This will lead to a new generation of personalized, rich multimedia communication services, e.g. peer-to-peer multimedia communication, IPTV etc.

These services can be based on the IP Multimedia Subsystem (IMS) architecture, which is the technology defined by the Third Generation Partnership Project (3GPP) to provide IP Multimedia services over mobile communication networks (3GPP TS 22.228, TS 23.228, TS 24.229, TS 29.228, TS 29.229, TS 29.328 and TS 29.329 Release 5 and Release 6). The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Other multimedia applications which can be used for media transmission and control include Real-time Transport Protocol and Real-time Transport Control Protocol (RTP/RTCP), Message Session Relay Protocol (MSRP), and Hyper Text Transfer Protocol (HTTP).

MSRP messages are Multi Media Messages that can include pager mode messages, Chat, and File transfers. Whilst the handling of MSRP messages is becoming established within fixed networks, there are difficulties in introducing MSRP messaging in mobile networks.

Multi Media Messaging services are based on SIP for signalling and MSRP for transporting media. Both protocols are specified in IETF (J. Rosemberg et al., “SIP: Session Initiation Protocol,” Internet Engineering Task Force, RFC 3261, June 2002; Ben Campbell et al., “The Message Session Relay Protocol,” Internet Engineering Task Force, Internet Draft (Work in Progress), February 2006). The service layer for messaging services are specified in OMA IM TS and 3GPP 24.247

The current MSRP protocols provide for binary information being included directly in an MSRP message. This can create problems where part of the content of the MSRP message includes pictures or other large binary files. MSRP and SIP protocols are used to inform the receiving terminal of the number of bytes included in the total message, but the receiving terminal cannot interpret the data included in the message until the whole message is delivered. When a user receives an MSRP message at, for example, his mobile terminal, the client has to wait until the complete MSRP message is transferred before it can start to display the information contained therein. In a mobile network with low bandwidth, the user perceives that there is a long delay between the start of receiving the message and the message being displayed, and this may discourage the user from using the messaging service.

### SUMMARY OF THE INVENTION

In order to reduce the time it takes for an MSRP message to display on a user's device, the inventors have devised a method of generating an MSRP message that permits incremental handling of the content of the message as the content is received at the client's device, rather than waiting for the entire message to be received. This is achieved by including a description of the MSRP content at the beginning of the MSRP message. The description indicates the contents of a multipart MSRP body, and includes a set of instructions for handling each part in the body as they are received at the client. The handling of the MSRP message can begin as soon the first part of the MSRP content is received.

According to a first aspect of the invention, there is provided a method of transmitting a multimedia message over a network, the method comprising:
generating at a first terminal a Message Session Relay Protocol message, the message comprising a plurality of data portions and a description portion, the description portion comprising instructions for individually handling each data portion;
sending the message from the first terminal such that the description portion is sent ahead of the data portions;
receiving the description portion at a second terminal;
receiving the data portions at the second terminal;
handling at the second terminal each data portion in accordance with the instructions for handling the data portions.

It is preferred that the description portion comprises an Extensible Markup Language, XML, or an Extensible Hypertext Markup Language, XHTML, document.

The description portion may be arranged to be sent in a first chunk of the Message Session Relay Protocol message.

The data portion may comprise an Extensible Markup Language, XML, or an Extensible Hypertext Markup Language, XHTML, document.

According to a second aspect of the invention, there is provided a method of operating a terminal to generate a Message Session Relay Protocol message, the method comprising:
generating a plurality of data portions and a description portion, the description portion comprising instructions for individually handling each data portion;
structuring the MSRP message such that the description portion is arranged to be sent ahead of the data portions.

According to a third aspect of the invention, there is provided a method of operating a terminal to handle a Message Session Relay Protocol message, the message comprising a plurality of data portions and a description portion, the description portion comprising instructions for individually handling each data portion, the method comprising:
receiving the description portion;
receiving the data portions;
individually handling each data portion in accordance with the instructions for handling the data portions.

According to a fourth aspect of the invention, there is provided a user terminal comprising:
means to generate a Message Session Relay Protocol message, the message comprising a plurality of data portions and a description portion, the description portion comprising instructions for individually handling each data portion;
means to structure the MSRP message such that the description portion is arranged to be sent before the data portions.

According to a fifth aspect of the invention, there is provided a user terminal comprising:
means to receive a Message Session Relay Protocol message, the message comprising a plurality of data portions and a description portion, the description portion comprising instructions for individually handling each data portion;
handling each data portion in accordance with the instructions for handling the data portions.

According to a sixth aspect of the invention, there is provided a signal containing a Message Session Relay Protocol message, the message comprising:
a plurality of data portions;
a description portion comprising instructions for individually handling each data portion;
wherein the message is structured such that the description portion is arranged to be sent ahead of the data portions.

### BRIEF DESCRIPTION OF THE DRAWINGS

FIG. 1 illustrates schematically the IP Multimedia Subsystem;

FIG. 2 illustrates schematically a Message Session Relay Protocol (MSRP) message structure in accordance with one embodiment of the invention;

FIG. 3 is a flowchart showing how a receiving terminal handles the MSRP message of the invention; and

FIG. 4 illustrates schematically a Message Session relay Protocol message structure in accordance with a second embodiment of the invention.

### DETAILED DESCRIPTION OF CERTAIN EMBODIMENTS

A first user may typically wish to send a Message Session Relay Protocol (MSRP) message to a second user as part of a chat session or as a file for the second user to look at later. In a typical scenario, the first user will send the message from his terminal (the sending terminal) to the second user's terminal (the receiving terminal).

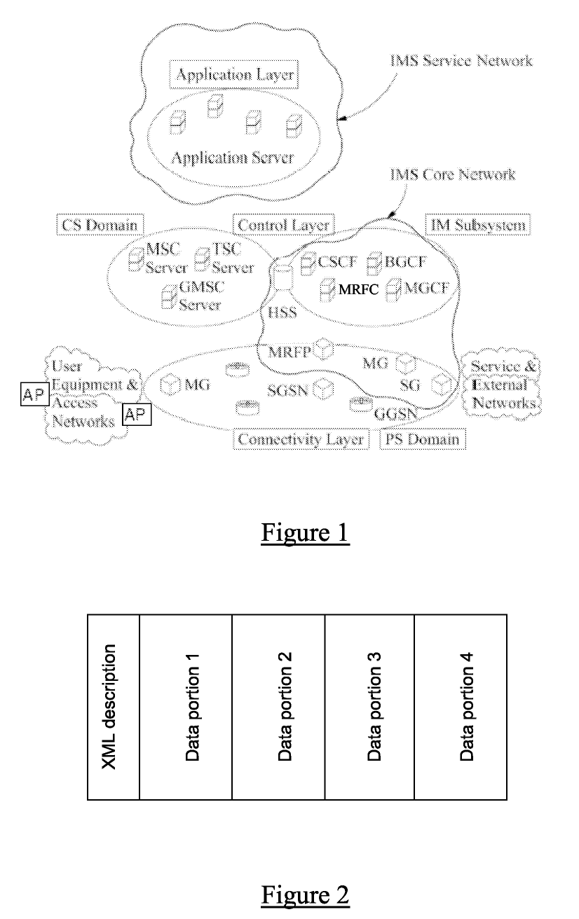

According to a first specific embodiment the message includes an Extended Markup Language (XML) page that includes pictures, audio and text data. This is illustrated in FIG. 2, in which the MSRP message includes an XML description and a plurality of data portions. The data portions are different portions of the MSRP message, for example pictures, audio and text. The XML description page contains instructions on how to handle the data portions, for example how and where to render the images on the screen, how to display the text files, and the order in which to display the data portions.

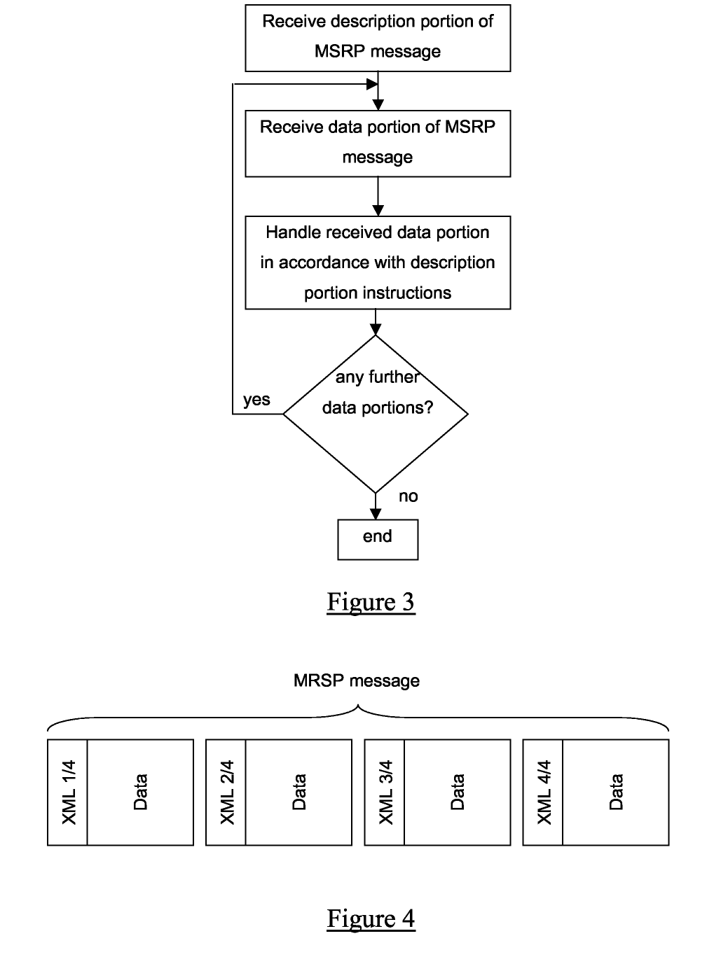

When the MSRP message is sent, it is sent in one or more chunks. Each chunk may comprise one or more data portions, and the first chunk to be sent comprises either the XML page or the XML page in addition to one or more data portions. FIG. 3 is a flowchart showing how a receiving terminal handles the MSRP message. The receiving terminal receives the first chunk that contains the XML description page, which describes how to handle the data portions in the message. As further chunks arrive containing the data portions, the receiving client begins to handle the data portions in accordance with the instructions in the XML descriptions. This allows images and text to be displayed, and sound or video clips to be played, as they are received and before the entire MSRP message has been received.

The MSRP message may be structured so that data portions are sent in a predetermined order, for example it may send text portions first to ensure that the second user can read the message as soon as possible after the second terminal begins to receive the message, followed by thumbnail pictures which have a small file size and will therefore be received quickly, followed by larger files such as pictures, video or audio clips. Further more, it is possible for a data portion, such as a picture file, to be split up and the split components of the picture may be sent in separate chunks.

The sending client of the sending terminal adds the attribute reading—restructured to the XML description portion of the MSRP message. This allows the terminal to read the XML document first, then small binaries (as thumbnails) and then large binaries (as photos etc.)

The sending application (in this case the application is on the first user's terminal) creates an XML/XHTML page and refers to binaries by references to data file(s) in the same folder. The application may include the binaries in an XML/XHTML document or simply put each binary in its own file.

When sending the MSRP message, the client follows RFC 2046, 2387 and sets content type to multipart/mixed as follows:

MIME-Version: 1.0
Content-type: multipart/mixed; boundary=“simple boundary”

Each data file has an id that refers to a file name in the XML/XHTML document:
Content-type: multipart/mixed; boundary=“simple boundary”
simple boundary
Content-type: application/xml; charset=utf-16;
Content-Description: Main Document

<!DOCTYPE html PUBLIC “-//W3C//DTD XHTML 1.0 Strict//EN”
“http://www.w3.org/TR/xhtml1/DTD/xhtml1-strict.dtd”[
<!ATTLIST html
xmlns:xsi CDATA #FIXED “http://www.w3.org/2001/XMLSchema-instance”
xsi:schemaLocation CDATA #IMPLIED

>
]>
<html xmlns=“http://www.w3.org/1999/xhtml” lang=“en” xml:lang=“en”

xmlns:xsi=“http://www.w3.org/2001/XMLSchema-instance”
xsi:schemaLocation=“http://www.w3.org/1999/xhtml

http://www.w3.org/2002/08/xhtml/xhtml1-strict.xsd”>

...

<ul>

...
<a href=“file:/file1/#night-spots”>Local Night Spots</a>
...

</ul>
</html>

```
  --simple boundary
  Content-type: application/xml; charset=utf-16
  Content-Description: File 1
  <!DOCTYPE html PUBLIC “-//W3C//DTD XHTML 1.0  Strict//EN”
“http://www.w3.org/TR/xhtml1/DTD/xhtml1-strict.dtd”[
<!ATTLIST html
xmlns:xsi CDATA #FIXED “http://www.w3.org/2001/XMLSchema-instance”
xsi:schemaLocation CDATA #IMPLIED
```

>
]>
<html xmlns=“http://www.w3.org/1999/xhtml” lang=“en” xml:lang=“en”

xmlns:xsi=“http://www.w3.org/2001/XMLSchema-instance”
xsi:schemaLocation=“http://www.w3.org/1999/xhtml

http://www.w3.org/2002/08/xhtml/xhtml1-strict.xsd”>

...

<ul>

...
<li><a href=“#night-spots”>Local Night Spots</a></li>
...

</ul>
</html>

simple boundary
Content-type: image/jpeg;
Content-Description: File 2
PICTURE 1
simple boundary

The sending client includes the XML description file in the first SEND chunk that is sent. As soon as one multipart is sent the send chunk is terminated and the next SEND chunk starts with the next multipart message. Each chunk may include more than one data portion.

The receiving terminal receives XML description document first, as it is sent in the first SEND chunk. The receiving client can now start reading the XML file and handle any data portions contained in the XML file or sent with the XML description in the first chunk. As soon the second multipart chunk is loaded at the receiving terminal, the receiving client can handle the data portions in the second multipart chunk. This process is repeated until all of the multipart chunks have arrived at the receiving terminal and the data portions have been handled. The receiving client identifies that a logical part of the message is completed by the boundaries in the XML content.

In an alternative embodiment, the MSRP message as shown in FIG. 4 is not sent in chunks, but broken down into separate messages that are clustered together. Each SEND starts with a small descriptor XML document that informs the receiving terminal that this SEND is actually number x out of y in a chain of SEND requests that are clustered together. Each descriptor XML document describes the referenced file (instead of using id). The receiving client then treats the send request according to the description of the first specific embodiment.

It will be appreciated by the person of skill in the art that various modifications may be made to the above described embodiments without departing from the scope of the present invention. For example, the embodiments are described with one user sending an instant message to another user. However, the message may be generated automatically and sent to a number of users. For example when providing a sporting update service reporting a football match, a message may be automatically generated that reports that a goal has been scored, includes an audio clip of a crowd cheering and displays a picture of the scoring player.

1. A system for transmitting a multimedia message over a network, the system comprising:
means for generating at a first terminal, a Message Session Relay Protocol message, the message comprising a plurality of data portions and a description portion, the description portion comprising instructions for individually handling each data portion;
means for sending the message from the first terminal such that the description portion is sent ahead of the data portions;
means for receiving the description portion at a second terminal;
means for receiving the data portions at the second terminal; and
means for handling at the second terminal, each data portion in accordance with the instructions for handling the data portions.

2. The system as claimed in claim 1, wherein the description portion comprises an Extensible Markup Language (XML) document or an Extensible Hypertext Markup Language (XHTML) document.

3. The system as claimed in claim 1, wherein the description portion is sent in a first block of the Message Session Relay Protocol message.

4. The system as claimed in claim 2, wherein at least one of the data portions also includes an XML document or an XHTML document.

5. A method of operating a user terminal to generate a Message Session Relay Protocol (MSRP) message, the method comprising:
generating a plurality of data portions and a description portion, the description portion comprising instructions for individually handling each data portion; and
structuring the MSRP message such that the description portion is be sent ahead of the data portions.

6. A method of operating a user terminal to handle a received Message Session Relay Protocol message, the message comprising a plurality of data portions and a description portion, the description portion comprising instructions for individually handling each data portion, the method comprising:
receiving the description portion at the user terminal;
receiving the data portions at the user terminal; and
individually handling each data portion in accordance with the instructions for handling the data portions.

7. A user terminal comprising:
means for generating a Message Session Relay Protocol message, the message comprising a plurality of data portions and a description portion, the description portion comprising instructions for individually handling each data portion; and
means for structuring the MSRP message such that the description portion is arranged to be sent before the data portions.

8. A user terminal comprising:
means for receiving a Message Session Relay Protocol message, the message comprising a plurality of data portions and a description portion, the description portion comprising instructions for individually handling each data portion;
means for extracting the instructions from the description portion; and
means for handling each data portion in accordance with the instructions for handling the data portions.

9. (canceled)
